(19) United States
(12) Patent Application Publication
(10) Pub. No.: US 2012/0156586 A1
(43) Pub. Date: Jun. 21, 2012

(54) FUEL DISTRIBUTION STRUCTURE AND FUEL CELL HAVING THE SAME

(75) Inventors: Ku-Yen Kang, Hsinchu City (TW); Ching-Jung Liu, Hsinchu County (TW); Chun-Ho Tai, Hsinchu City (TW); Chiou-Chu Lai, Hsinchu County (TW)

(73) Assignee: INDUSTRIAL TECHNOLOGY RESEARCH INSTITUTE, Hsinchu (TW)

(21) Appl. No.: 13/030,149

(22) Filed: Feb. 18, 2011

(30) Foreign Application Priority Data
Dec. 16, 2010 (TW) 99144306

(51) Int. Cl. H01M 8/10; H01M 8/04

(52) U.S. Cl. 429/480; 429/513; 429/482

(57) ABSTRACT

A fuel distribution structure including a first material layer, a second material layer, a flow channel layer and a filler is provided. The first material layer has a fuel inlet, the second material layer has a plurality of fuel outlets, the flow channel layer has a patterned flow channel, wherein the fuel inlet and the fuel outlets are covered by a distribution range of the patterned flow channel, and the filler is disposed in the patterned flow channel. In addition, a fuel cell having the above-mentioned fuel distribution structure is also provided.

### CROSS-REFERENCE TO RELATED APPLICATION

This application claims the priority benefit of Taiwan application serial no. 99144306, filed on Dec. 16, 2010. The entirety of the above-mentioned patent application is hereby incorporated by reference herein and made a part of this specification.

### BACKGROUND OF THE INVENTION

1. Field of the Application

The present application relates to a fuel cell. More particularly, the present application relates to a fuel distribution structure of a fuel cell.

2. Description of Related Art

With the rapid development of industry, the consumption of conventional energy source such as coal, petroleum, and natural gas is increasingly high, and due to the limited storage of natural energy source, novel alternative energy source may be researched and developed to substitute the conventional energy source, and the fuel cell is taken as an important and practical choice.

In brief, the fuel cell is substantially a power generator that converts chemical energy into electric energy by utilizing the reverse reaction of the water electrolysis. The proton exchanging membrane fuel cell mainly includes a membrane electrode assembly (MEA) and two electrode plates. The MEA includes a proton exchange membrane, an anode catalyst layer, a cathode catalyst layer, an anode gas diffusion layer (GDL) and a cathode GDL. The anode catalyst layer and the cathode catalyst layer are respectively disposed on two sides of the proton conducting membrane, and the anode GDL and the cathode GDL are respectively disposed on the anode catalyst layer and the cathode catalyst layer. Furthermore, two electrode plates include an anode and a cathode, which are respectively disposed on the anode GDL and the cathode GDL.

Currently, the common proton exchanging membrane fuel cell is Direct Methanol Fuel Cell (DMFC), which directly takes the methanol aqueous solution as the source for supplying fuel, and generates currents through the relevant electrode reaction between methanol and oxygen. The reaction formulas of the DMFC are shown as follows:

Anode: CH₃OH+H₂O→CO₂+6H⁺+6e⁻

Cathode: 3/2O₂+6H⁺+6e⁻→3H₂O

Conventionally, fuel with low concentration is applied to the DMFC directly, and a cooler is used to recycle the water generated by cathode to enhance the utilization efficiency of the fuel. However, the conventional DMFC suffers lots of restrictions when being applied to portable electronic devices. Accordingly, various fuel cells using fuel with high concentration are proposed in U.S. Publication No. 2010/0124677, CN Publication No. 101573821, and U.S. Publication No. 2010/0190087. In order to satisfy design requirements of portable electronic devices, the fuel cells should be compact and light. In addition, the fuel cells should normally operate under all possible orientations. Currently, various solutions such as U.S. Publication No. 2010/0124677, CN Publication No. 101632195, CN Publication No. 101573821 and U.S. Publication No. 2010/0190087 are proposed to discuss how the fuel cells operate normally under all possible orientations.

When a small amount of fuel with high concentration is applied to the anode of the DMFC by a liquid pump, how to uniformly distribute the small amount of fuel in the DMFC is very important. In the disclosure of U.S. Publication No. 2010/0124677, a planar fuel distribution structure having tiny spiral fuel channels is disclosed, and two surfaces of the planar fuel distribution structure are covered by methanol diffusion films. In the disclosure of CN Publication No. 101632195, a fuel distribution structure having a plurality of flow channels is disclosed. Each of the flow channels has a channel outlet and the diameter of the channel outlets must be smaller than the size of the flow channels. In CN Publication No. 101632195, capillarity generated from the flow channels is utilized to prevent the fuel from leaking when the fuel distribution structure operates under some orientations. In the disclosures of CN Publication No. 101573821 and U.S. Publication No. 2010/0190087, fuel distribution structures having a plurality of flow channels are disclosed. Each of the flow channels has a plurality of branches and each branch has a channel outlet. In addition, the diameter of the channel outlets must be greater than the size of the flow channels. In CN Publication No. 101573821 and U.S. Publication No. 2010/0190087, capillarity generated from the branches of the flow channels is utilized to prevent the fuel from leaking when the fuel distribution structure operates under some orientations.

Sealed and tiny flow channels (the width thereof is about 10 micrometers) are currently utilized to uniformly distribute the small amount of fuel. When fabricating the sealed and tiny flow channels, it is quite difficult to control the size (width) of the sealed and tiny flow channels.

### SUMMARY OF THE INVENTION

The present application provides a fuel cell and a fuel distribution structure thereof. The fuel cell and the fuel distribution structure can normally operate under all possible orientations.

The present application provides a fuel distribution structure including a first material layer, a second material layer, a flow channel layer and a filler. The first material layer has a fuel inlet, the second material layer has a plurality of fuel outlets, the flow channel layer has a patterned flow channel, wherein the fuel inlet and the fuel outlets are covered by a distribution range of the patterned flow channel, and the filler is disposed in the patterned flow channel.

The present application also provides a fuel cell including a membrane electrode assembly (MEA), a cathode current collector, an anode current collector and the above-mentioned fuel distribution structure. The cathode current collector and the anode current collector are respectively disposed at two opposite sides of the membrane electrode assembly. In addition, the fuel distribution structure and the anode current collector are located at the same side of the membrane electrode assembly.

In order to the make the aforementioned and other objects, features and advantages of the present application, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a fuel cell according to an embodiment of the present application.

FIG. 2 is a schematic view of a fuel cell according to an embodiment of the present application.

FIG. 3A through FIG. 3E are cross-sectional views respectively illustrating fuel distribution structures according to various embodiments of the present application.

### DESCRIPTION OF EMBODIMENTS

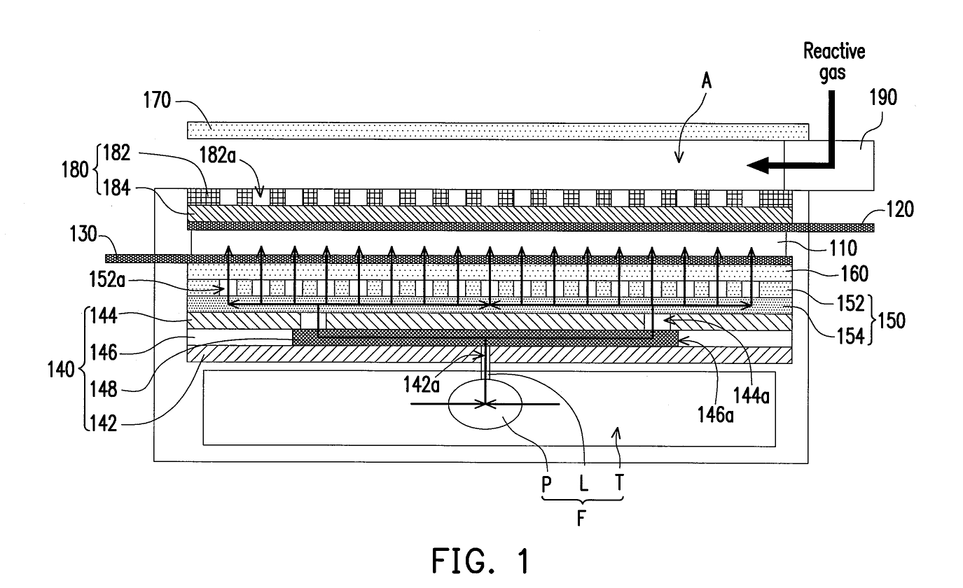

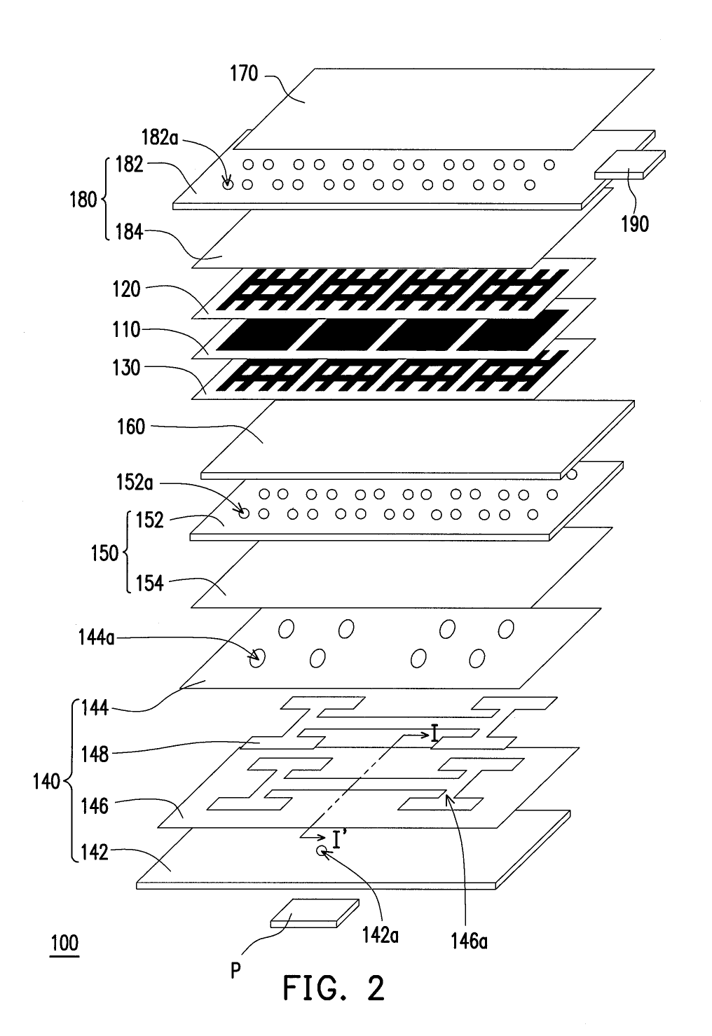

FIG. 1 is a schematic cross-sectional view of a fuel cell according to an embodiment of the present application. FIG. 2 is a schematic view of a fuel cell according to an embodiment of the present application. Referring to FIG. 1 and FIG. 2, the fuel cell 100 of the present embodiment includes a membrane electrode assembly (MEA) 110, a cathode current collector 120, an anode current collector 130 and a fuel distribution structure 140. The cathode current collector 120 and the anode current collector 130 are respectively disposed at two opposite sides of the membrane electrode assembly 110. in addition, the fuel distribution structure 140 and the anode current collector 130 are located at the same side of the membrane electrode assembly 110.

In addition to the membrane electrode assembly 110, the cathode current collector 120 and the anode current collector 130, the fuel cell 100 may further include a fuel uniform layer 150 disposed between the anode current collector 130 and the fuel distribution structure 140. For example, the fuel uniform layer 150 includes a first apertured plate 152 and a gas barrier layer 154, wherein the first apertured plate 152 is disposed between the anode current collector 130 and the gas barrier layer 154. In the present embodiment, the first apertured plate 152 has a plurality of first apertures 152a, and the gas barrier layer 154 is a material layer capable of absorbing fuel and obstructing gas, for example. In another embodiment, the fuel uniform layer 150 may only include the gas barrier layer 154. In other words, the fuel uniform layer 150 does not include the first apertured plate 152.

In the present embodiment, the fuel cell 100 may further include a gas-permeable layer 160 disposed between the fuel uniform layer 150 and the anode current collector 130. As shown in FIG. 1 and FIG. 2, the gas-permeable layer 160 is disposed between the first apertured plate 152 and the anode current collector 130. For example, the gas-permeable layer 160 is a gas-permeable material layer capable of absorbing fuel. In addition, the gas barrier layer 154 and the gas-permeable layer 160 are fabricated by materials that are wettable by fuel. In other words, the contact angle of the gas barrier layer 154 and fuel (e.g. methanol) and the contact angle of the gas-permeable layer 160 and fuel are smaller than 90 degrees. It is noted that the above-mentioned “wettable by fuel” is not equivalent with “hydrophilic”. When the contact angle of a material and fuel (e.g. methanol) is smaller than 90 degrees, the contact angle of the material and water may possible be greater than 90 degree, and accordingly the material is considered as “wettable by fuel” but not “hydrophilic”.

The fuel cell 100 of the present embodiment may further includes a cover 170, a cathode moisture-maintaining layer 180 and a gas transmission device 190, wherein the cathode moisture-maintaining layer 180 is disposed between the cover 170 and the cathode current collector 120, and a reactive gas flow channel A is formed between the cathode moisture-maintaining layer 180 and the cover 170. In addition, a reactive gas is transmitted to the reactive gas flow channel A by the gas transmission device 190 such that the reactive gas can diffuse into the membrane electrode assembly 110 easily. For example, the cathode moisture-maintaining layer 180 includes a second apertured plate 182 and a hydrophobic gas-permeable layer 184, wherein the second apertured plate 182 has a plurality of second apertures 182a, and the hydrophobic gas-permeable layer 184 is disposed between the second apertured plate 182 and the cathode current collector 120.

In the present embodiment, the cover 170 used may be any gas-impermeable substrates such as metal substrates, plastic substrates, printed circuit boards, substrates having a hydrophilic layer on the inner surface thereof, substrates without a hydrophilic layer covering the inner surface thereof or other suitable substrates. Besides, the gas transmission device 190 is a fan, a blower or other suitable gas transmission devices.

In the present embodiment, the fuel cell 100 may further include a fuel supply unit F for supplying fuel to the fuel distribution structure 140. For example, the fuel supply unit F includes a pump P, a fuel tank T and a piping L connecting the fuel tank T and the fuel distribution structure 140.

The fuel uniform layer 150, the gas-permeable layer 160, the cover 170, the cathode moisture-maintaining layer 180, the gas transmission device 190 and the fuel supply unit F mentioned above are optional elements of the fuel cell 100, omission (simplification) of these optional elements can be made in accordance with actual design requirements of the fuel cell 100.

In order to apply the fuel cell 100 of the present application to portable electronic devices, the fuel distribution structure 140 should normally operate under all possible orientations. The details of the fuel distribution structure 140 are further exemplified in the following.

In the present embodiment, the fuel distribution structure 140 includes a first material layer 142, a second material layer 144, a flow channel layer 146 and a filler 148. The first material layer 142 has a fuel inlet 142a, the second material layer 144 has a plurality of fuel outlets 144a, the flow channel layer 146 has a patterned flow channel 146a, wherein the fuel inlet 142a and the fuel outlets 144a are covered by a distribution range of the patterned flow channel 146a. In other words, the fuel inlet 142a and the fuel outlets 144a are communicated with the patterned flow channel 146a. Moreover, the filler 148 is disposed in the patterned flow channel 146a. For instance, the diameter of the fuel inlet 142a ranges from 0.1 mm to 10 mm, and preferably, the diameter of the fuel inlet 142a is 1.2 mm. The diameter of the fuel outlets 144a ranges from 0.5 mm to 20 mm, and preferably, the diameter of the fuel outlets 144a ranges from 2 mm to 10 mm. It is noted that the patterned flow channel 146a for transmitting fuel are defined by the first material layer 142, the second material layer 144 and the flow channel layer 146. Except the regions where the fuel inlet 142a and the fuel outlets 144a are located, cross-sections of the patterned flow channel 146a are closed or sealed cross-sections.

The fuel outlets 144a in the second material layer 144 are symmetrically distributed with respect to the fuel inlet 142a as a symmetry center. However, the distribution of the fuel outlets 144a is not limited in the present application, one ordinary skilled in the art may modify the distribution of the fuel outlets 144a in accordance with design requirements of the fuel cell 100. For instance, the fuel inlet 142a may be not located at the center of the first material layer 142 and the fuel outlets 144a may not distribute asymmetrically. One ordinary skilled in the art may properly adjust the path of the flow channels such that flow-rates of fuel output by each of the fuel outlets 144a are substantially identical. Specifically, in order to obtain identical flow-rates of fuel output by each fuel outlet 144a, one skilled in the art may make the path lengths from the fuel inlet 142a to each of the fuel outlets 144a equal. In other embodiments of the present application, the path lengths from the fuel inlet 142a to each of the fuel outlets 144a may be different from one another and each of the flow channels may have different sizes (e.g. width of the flow channels are different). The capillary force provided by the filler 148 and the flow channels makes the transmission velocity of the fuel transmitted by narrow flow channels faster such that the flow-rates of the fuel transmitted by narrow flow channels and the flow-rates of the fuel transmitted by wide flow channels can be substantially identical.

It should be noted that the positions and amount of the filler 148 can be determined according to design requirements of the fuel cell 100. For instance, all regions of the patterned flow channel 146a are filled by the filler 148. Specifically, the regions of the patterned flow channel 146a that are corresponding to the fuel outlets 144a are filled by the filler 148. In other words, parts of the filler 148 are exposed by the fuel outlets 144a. In another embodiments, only parts regions of the patterned flow channel 146a are filled by the filler 148. Specifically, the filler 148 is not filled in the regions of the patterned flow channel 146a that are corresponding to the fuel outlets 144a. In the present embodiment, the material of the filler 148 is, for example, a capillary materials or other suitable materials. For example, the contact angle of the filler 148 and the fuel (e.g. methanol) is smaller than 90 degrees. In other words, the filler 148 is wettable by fuel.

Since the filer 148 is filled in the patterned flow channel 146a, the distribution of the fuel transmitted in the patterned flow channel 146a is uniform. In this case, the fuel distribution structure 140 is capable of operating under all possible orientations normally. In the prior arts, in order to uniformize the distribution of the fuel transmitted by the tubular flow channel, the size or the cross section of the tubular flow channels is required to be very small (e.g. width of the tubular flow channels is about or less than 10 micrometers). In the present application, since the patterned flow channel 146a is filled by the filler 148, there is no need to fabricate the patterned flow channel 146a having very small size or cross section. The capillary force provided by the filler 148 and the patterned flow channel 146a makes the fuel to distribute in the patterned flow channel 146a uniformly. In the present embodiment, the width of the patterned flow channel 146a is not limited to be about or less than 10 micrometers. In other words, the width or the depth of the patterned flow channel 146a may be greater than 10 micrometers. In this case, the distribution of the fuel in the fuel distribution structure 140 is still uniform. When the width or depth of the patterned flow channel 146a is great enough, minor error in width or depth of the patterned flow channel 146a can be ignored. Accordingly, it is easy to fabricate the patterned flow channel 146a of the present application. In the present embodiment, the size (width, depth or cross section) of the patterned flow channel 146a is not limited to be greater than those of conventional flow channels. When the fabrication processes are properly controlled, the filler 148 may be filled in the small-sized patterned flow channel 146a (e.g. the width of the small-sized patterned flow channel 146a is about or less than 10 micrometers) and a strong capillary force is still provided thereby.

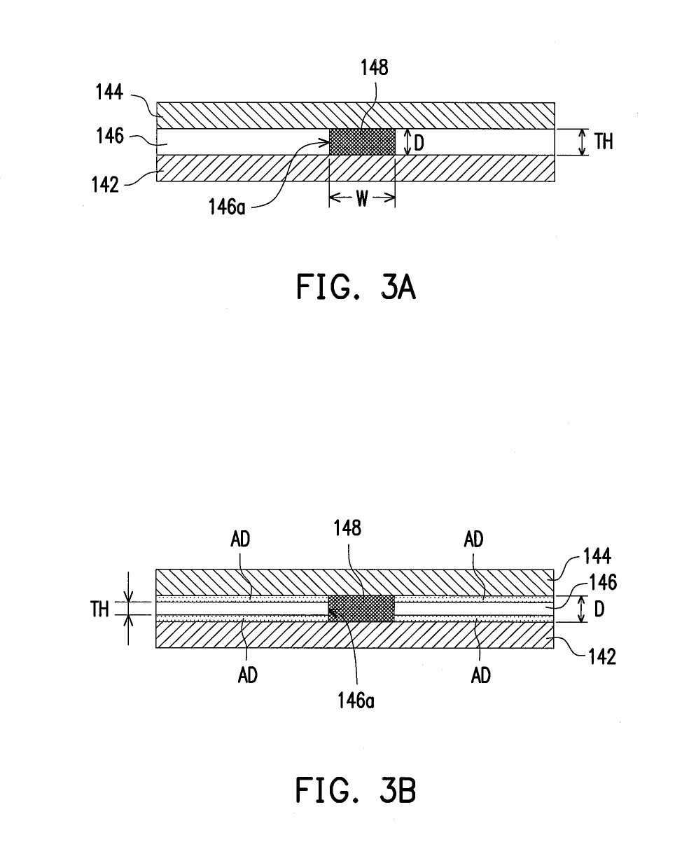

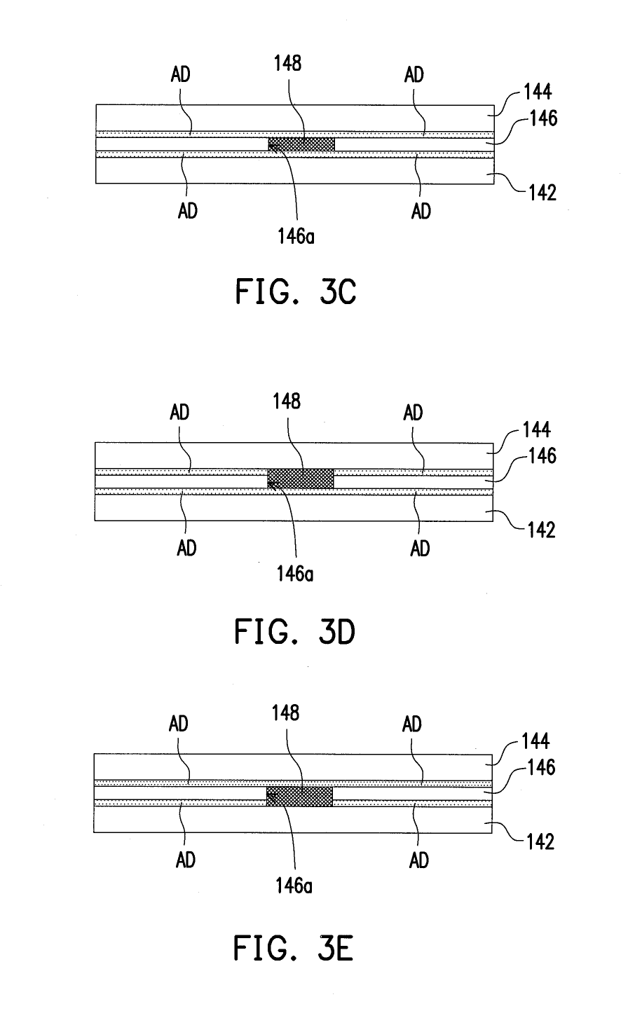

FIG. 3A through FIG. 3E are cross-sectional views respectively illustrating fuel distribution structures according to various embodiments of the present application. FIG. 3A and FIG. 3B are schematic cross-sectional views taken along the section line I-I′ in FIG. 1. Referring to FIG. 3A, the flow channel layer 146 sandwiched between the first material layer 142 and the second material layer 144 is an adhesive. The flow channel layer 146 is, for example, a B-stage adhesive or other adhesives suitable for adhering with the first material layer 142 and the second material layer 144. In an alternate embodiment, the materials of the flow channel layer 146 may be materials having no adhesion. The materials of the flow channel layer 146 may be epoxy, polyimide and so on. As shown in FIG. 3A, the flow channel layer 146 having no adhesion is pressed and directly bonded with the first material layer 142 and the second material layer 144. For instance, the first material layer 142 and the second material layer 144 are directly pressed onto two surfaces of the flow channel layer 146 so as to directly bond the flow channel layer 146 with the first material layer 142 and the second material layer 144.

In the present embodiment, the thickness TH of the flow channel layer 146 and the depth of the patterned flow channel 146a are substantially the same. For example, the thickness TH of the flow channel layer 146 and the depth of the patterned flow channel 146a range from 0.01 mm to 2 mm, and preferably, the thickness TH of the flow channel layer 146 and the depth of the patterned flow channel 146a range from 0.04 mm to 0.1 mm. Furthermore, the width W of the patterned flow channel 146a ranges from 0.5 mm to 20 mm, and preferably, the width W of the patterned flow channel 146a ranges from 2 mm and 10 mm. It is noted that the patterned flow channel 146a of the flow channel layer 146 may be fabricated by cutting the adhesive (e.g. B-stage adhesive), epoxy, polyimide and so on. The fabrication of the patterned flow channel 146a of the patterned flow channel 146a is very simple. When size deviation of the patterned flow channel 146a resulted from manufacturing error or overflow of adhesive occurs, the fuel distributes uniformly because the size deviation is much smaller than the size of the patterned flow channel 146a.

Referring FIG. 3B through FIG. 3E, when the flow channel layer 146 is fabricated from materials having no adhesion, various adhesives can be used to adhere with the first material layer 142 and the second material layer 144. It is noted that the materials of the flow channel layer 146 may be the same as those of the first material layer 142 and the second material layer 144. In other words, the flow channel layer 146 and the first material layer 142 are formed in one piece or the flow channel layer 146 and the second material layer 144 are formed in one piece. The flow channel layer 146 having the patterned flow channel 146a and one of the first material layer 142 and the second material layer 144 can be simultaneously formed by a stainless substrate. For instance, since the depth of the patterned flow channel 146a ranges from 0.01 mm to 2 mm, the thickness of the stainless substrate should be greater than the depth of the patterned flow channel 146a. The patterned flow channel 146a is formed by etching or cutting, for example.

Although the present invention has been disclosed above by the embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A fuel distribution structure, comprising:
a first material layer having a fuel inlet;
a second material layer having a plurality of fuel outlets;
a flow channel layer disposed between the first material layer and the second material layer, the flow channel layer having a patterned flow channel, the fuel inlet and the fuel outlets being covered by a distribution range of the patterned flow channel; and
a filler disposed in the patterned flow channel.

2. The fuel distribution structure of claim 1, wherein a diameter of the fuel inlet ranges from 0.1 mm to 10 mm.

3. The fuel distribution structure of claim 1, wherein a diameter of each of the fuel outlets ranges from 0.5 mm to 20 mm.

4. The fuel distribution structure of claim 1, wherein the fuel outlets in the second material layer are symmetrically distributed with respect to the fuel inlet as a symmetric center.

5. The fuel distribution structure of claim 1, wherein a thickness of the flow channel layer and a depth of the patterned flow channel are substantially the same.

6. The fuel distribution structure of claim 1, wherein a thickness of the flow channel layer is smaller than a depth of the patterned flow channel.

7. The fuel distribution structure of claim 1, wherein a thickness of the flow channel layer ranges from 0.01 mm to 2 mm.

8. The fuel distribution structure of claim 1, wherein a width of the patterned flow channel ranges from 0.5 mm to 20 mm.

9. The fuel distribution structure of claim 1, wherein a material of the filler comprises capillary materials.

10. The fuel distribution structure of claim 1, wherein a plurality of regions of the patterned flow channel corresponding to the fuel outlets are filled by the filler.

11. The fuel distribution structure of claim 1, wherein a plurality of regions of the patterned flow channel corresponding to the fuel outlets are not filled by the filler.

12. A fuel cell, comprising:
a membrane electrode assembly;
an anode current collector;
a cathode current collector, wherein the anode current collector and the cathode current collector are disposed at two opposite sides of the membrane electrode assembly;
a fuel distribution structure, the fuel distribution structure and the anode current collector are located at the same side of the membrane electrode assembly, the fuel distribution structure comprising:
a first material layer having a fuel inlet;
a second material layer having a plurality of fuel outlets;
a flow channel layer disposed between the first material layer and the second material layer, the flow channel layer having a patterned flow channel, the fuel inlet and the fuel outlets being covered by a distribution range of the patterned flow channel; and
a filler disposed in the patterned flow channel.

13. The fuel cell of claim 12, wherein a diameter of the fuel inlet ranges from 0.1 mm to 10 mm.

14. The fuel cell of claim 12, wherein a diameter of each of the fuel outlets ranges from 0.5 mm to 20 mm.

15. The fuel cell of claim 12, wherein the fuel outlets in the second material layer are symmetrically distributed with respect to the fuel inlet as a symmetric center.

16. The fuel cell of claim 12, wherein a thickness of the flow channel layer and a depth of the patterned flow channel are substantially the same.

17. The fuel cell of claim 12, wherein a thickness of the flow channel layer is smaller than a depth of the patterned flow channel.

18. The fuel cell of claim 12, wherein a thickness of the flow channel layer ranges from 0.01 mm to 2 mm.

19. The fuel cell of claim 12, wherein a width of the patterned flow channel ranges from 0.5 mm to 20 mm.

20. The fuel cell of claim 12, wherein a material of the filler comprises capillary materials.

21. The fuel cell of claim 12, wherein a plurality of regions of the patterned flow channel corresponding to the fuel outlets are filled by the filler.

22. The fuel cell of claim 12, wherein a plurality of regions of the patterned flow channel corresponding to the fuel outlets are not filled by the filler.

23. A fuel cell of claim 12, further comprising a fuel uniform layer disposed between the anode current collector and the fuel distribution structure.

24. A fuel cell of claim 23, wherein the fuel uniform layer comprises a gas barrier layer disposed between the anode current collector and the second material layer.

25. The fuel cell of claim 23, wherein the fuel uniform layer comprises:
a first apertured plate; and
a gas barrier layer, disposed between the first apertured plate and the second material layer.

26. A fuel cell of claim 23, further comprising a gas-permeable layer disposed between the fuel uniform layer and the anode current collector.

27. The fuel cell of claim 12, further comprising:
a cover;
a cathode moisture-maintaining layer disposed between the cover and the cathode current collector, wherein a reactive gas flow channel is formed between the cathode moisture-maintaining layer and the cover; and
a gas transmission device for supplying a reactive gas to the reactive gas flow channel

28. The fuel cell of claim 27, wherein the cathode moisture-maintaining layer comprises:
a second apertured plate; and
a hydrophobic gas-permeable layer, disposed between the second apertured plate and the cathode current collector.

29. A fuel cell of claim 12, further comprising a fuel supply unit for supplying fuel to the fuel distribution structure.
